(19) United States
(12) Patent Application Publication
(10) Pub. No.: US 2010/0324957 A1
(43) Pub. Date: Dec. 23, 2010

(54) System and Method for Program Management Using Systems Engineering Management Model

(76) Inventor: Steven E. Sumner, South Riding, VA (US)

Correspondence Address: THE JOHNS HOPKINS UNIVERSITYAPPLIED PHYSICS LABORA;OFFICE OF PATENT COUNSEL, 11100 JOHNS HOPKINS ROAD, MAIL STOP 7-156, LAUREL, MD, 20723-6099, US

(21) Appl. No.: 12/818,367

(22) Filed: Jun. 18, 2010

Related U.S. Application Data
(60) Provisional application No. 61/268,976, filed on Jun. 18, 2009.

(51) Int. Cl. G06Q 10/00

(52) U.S. Cl. 705/7

(57) ABSTRACT

The present invention solves the problems associated with traditional systems engineering process using a Systems Engineering Management Model (SEMM) which takes in to consideration all of the systems engineering capabilities critical to success (technical solution, risk, requirements, IPTs and interfaces, etc.) and provides for these capabilities in a timely and relevant manner using a single user interface to promote informed program execution. The SEMM automates the data manipulation processes and provides a single user interface and focal point to facilitate timely and informed decision-making. Such contemporaneous insight can help focus activities and resources to prioritize current issues, address critical ones, and provide indications of impending risks. Hence, the marginal utility of all program control activities is maximized.

The present application claims priority from U.S. Provisional Application No. 61/268,976 filed Jun. 18, 2009, the entire disclosure of which is incorporated herein by reference.

### BACKGROUND

The present invention relates to systems engineering methodology and software tools for tracking and managing health and status, requirements, and risk for a product, during any phase of its life cycle, as well as for promoting knowledge-based decisions for program execution.

It has been proposed that upfront investment in systems engineering can reduce overall life cycle cost for a product. One reason, perhaps, is that a comprehensive, coordinated approach to engineering development has a higher probability of identifying and correcting defects, preventing the occurrence of known unknowns, and reducing the consequences of unknown unknowns.

According to an NDIA (National Defense Industrial Association) study, the systems engineering capabilities inherent to the highest performing programs include risk management, requirements development and management, IPT (Integrated Product Team) capability, and combined requirements management with technical solution.

Current systems engineering and project management software tools do not address the spectrum of requisite systems engineering capabilities/knowledge in a single, focused source necessary for effective technical management. Traditional systems engineering processes and tools require collection from multiple sources resulting in delays associated with requesting, reformatting, reducing, and resolving to a representation applicable for management action. These methods are inefficient because of time delays, multiple requests (user interfaces), various data formats, and varying degrees of data currency.

What is needed is a single access point which takes in to consideration all of the systems engineering capabilities critical to success (technical solution, risk, requirements, IPTs and interfaces, etc.), instead of one or two factors considered by traditional management and systems engineering applications, and provides a single user interface and focal point to facilitate timely and informed decision-making.

### BRIEF SUMMARY

The present invention solves the problems associated with traditional systems engineering process using a Systems Engineering Management Model (SEMM) which takes in to consideration all of the systems engineering capabilities critical to success (technical solution, risk, requirements, IPTs and interfaces, etc.) and provides for these capabilities in a timely and relevant manner using a single user interface to promote informed program execution.

The SEMM automates the data manipulation processes and provides a single user interface and focal point to facilitate timely and informed decision-making. Such contemporaneous insight can help focus activities and resources to prioritize current issues, address critical ones, and provide indications of impending risks. Hence, the marginal utility of all program control activities is maximized.

The efficiency gained from systems engineering applications can be compounded by enhancing the effectiveness of these technical management functions. For example, the number (or scope) of program reviews can be reduced when program technical managers have a better understanding of program status and issues, and thus are able to focus the oft-limited resources available for reviews and other technical control activities. The reductions in scope and time required to effect technical management result in increased systems engineering efficiency. These gains can be realized if all information needed to facilitate informed decision-making, by program/technical managers, can be timely, accessible, comprehensive, and in a context germane to technical program controls.

Proper management of knowledge, especially of a program's health and status pertaining to risk, technical design (including interfaces and requirements), schedule, and cost, is key to the success of a program. To achieve this, the SEMM instantiates the knowledge model of a program's health and status by capturing and representing information necessary for technical management of a design solution.

In accordance with an aspect of the present invention, a device is provided for use with a first client, a second client and a display. The first client can perform a first function and can output first functional data based on a performance of the first function. The second client can perform a second function and can output second functional data based on a performance of the second function. The display can display an image. The device includes a receiver portion, a graphical user interface (GUI) portion and an entity operator portion. The receiver portion can receive the first functional data and the second functional data. The GUI portion has a display generator portion and can generate display data. The display generator portion can create a first icon and a second icon. The entity operator portion has a nowcasting portion, a forecasting portion, a simulating portion, a domain operator portion and a functional operator portion. The entity operator portion can create a first entity and a second entity based on the first function and the second function, respectively. The nowcasting portion can generate current state data based on the first functional data and the second functional data and related to a current state of the first client and a current state of the second client. The forecasting portion can generate future state data based on the first functional data and the second functional data and related to a future state of the first client and a future state of the second client. The simulating portion can generate simulated data based on the first functional data and the second functional data and related to a simulated state of the first client and a simulated state of the second client. The display data is based on at least one of the current state data, the future state data and the simulated data. The first icon and the second icon are based on the first entity and the second entity, respectively. The entity operator portion can further change at least one of the first entity and the second entity based on a change in at least one of the current state data, the future state data and the simulated data. The entity operator portion can further link the first entity and the second entity, such that a change in the first entity will generate a change in the second entity. The display generator portion can change at least one of the first icon or the second icon based on a change in at least one of the first entity and the second entity.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates an example system in accordance with an aspect of the present invention;

FIG. 2 illustrates an example embodiment of base station of the system of FIG. 1;

FIG. 3 illustrates an example embodiment of a processor of a base station in accordance with an aspect of the present invention;

FIG. 4 illustrates an example embodiment of an entity operator portion of a processor in accordance with an aspect of the present invention;

FIG. 5 illustrates an example embodiment of a GUI portion of a processor in accordance with an aspect of the present invention;

FIG. 6 illustrates an example embodiment of different entities generated by an entity operator in accordance with an aspect of the present invention;

FIG. 7 illustrates relationship between different entities in accordance with an aspect of the present invention;

FIG. 8 illustrates a relationship map showing links between different entities in accordance with an aspect of the present invention;

FIG. 9 illustrates an example embodiment of an entity with different characteristic data associated with it;

FIG. 10 illustrates an example embodiment of characteristic data with a change in one of the characteristics associated with it;

FIG. 11 illustrates a flow chart for main functional flow of SEMM in accordance with an aspect of the present invention;

FIG. 12 illustrates an example method for SEMM database and a GUI representation of the system domain model to be refreshed in accordance with an aspect of the present invention;

FIG. 13 illustrates an example method for the SEMM database uploading the latest data set for each entity in accordance with an aspect of the present invention;

FIG. 14 illustrates an example WBS dashboard for a system of systems using SEMM in accordance with an aspect of the present invention;

FIG. 15 illustrates an example product entity and its characteristic features in accordance with an aspect of the present invention;

FIG. 16 illustrates an example embodiment of a SEMM product entity with its management features expanded to display their associated attributes in accordance with an aspect of the present invention;

FIG. 17 illustrates an example entity hierarchy and characteristics using SEMM in accordance with an aspect of the present invention; and

FIG. 18 illustrates a more detailed example of entity hierarchy and characteristics in accordance with an aspect of the present invention.

### DETAILED DESCRIPTION

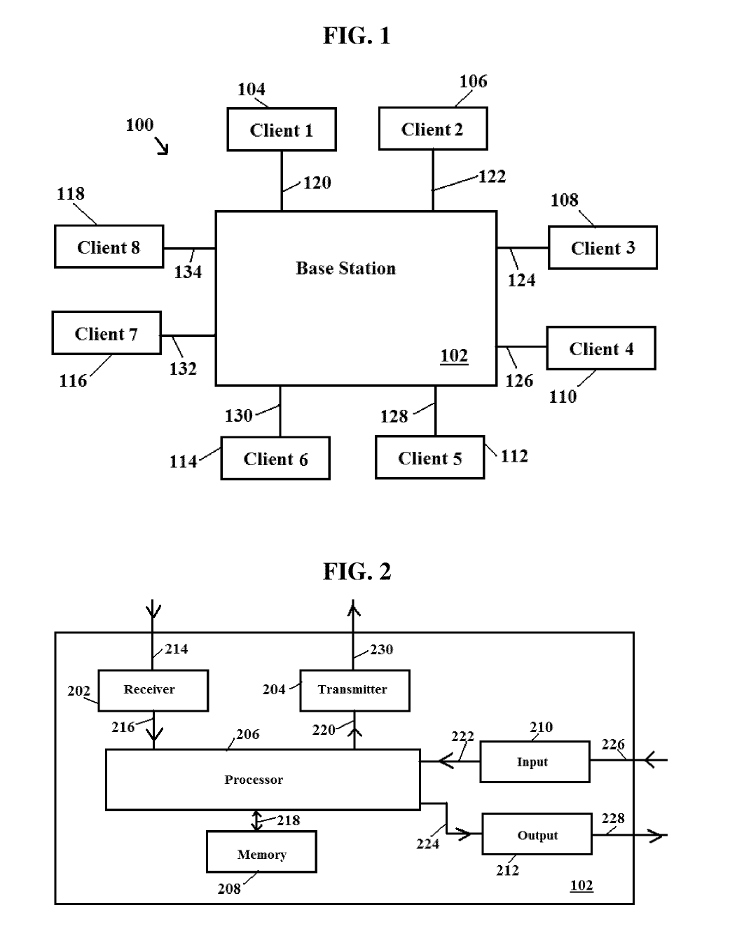

SEMM takes into consideration all of the systems engineering capabilities critical to success (technical solution, risk, requirements, IPTs and interfaces, etc.) and provides for these capabilities in a timely and relevant manner using a single user interface to promote informed program execution. This will be described in detail with reference to FIGS. 1-18.

FIG. 1 illustrates a system 100 in accordance with an aspect of the present invention.

As illustrated in the figure, system 100 includes a base station 102, a client 104, a client 106, a client 108, a client 110, a client 112, a client 114, a client 116 and a client 118. Each of clients 104, 106, 108, 110, 112, 114, 116 and 118 is a computer or network of computers operable to perform predetermined functions.

Base station 102 is arranged to communicate with client 104 via signal 120, with client 106 via signal 122, with client 108 via signal 124, with client 110 via signal 126, with client 112 via signal 128, with client 114 via signal 130, with client 116 via signal 132 and with client 118 via signal 134. FIG. 1 shows eight clients but system 100 may include any number of clients in communication with base station 102.

Signals 120, 122, 124, 126, 128, 130, 132 and 134 may be wired or wireless signals. Although, each of signals 120, 122, 124, 126, 128, 130, 132 and 134 are illustrated as distinct signals, they all may share a predetermined frequency band within a wireless medium. Signals typically embody computer-readable instructions, data structures, program modules, or other data in a modulated data signal such as a carrier wave or other transport mechanism and include any information-delivery media. Non-limiting examples of communications media, which may carry signals, include wired media, such as wired networks and direct-wired connections, and wireless media such as acoustic, radio, infrared, and other wireless media. The term “computer-readable media” as used herein includes both storage media and communications media.

Each client in communication with base station 102 is operable to perform a function or a sub-function and has one or more characteristics associated with it. An entity is a SEMM representation of a system product or process. Herein, a characteristic may be used to refer to entity features, attributes, properties, elements, and all data defining the entity. A client may be any source of data relevant to system/program as represented by the entity within the SEMM. Base station 102 manages each client and maintains relationship between the clients. Base station 102 will now be further explained using FIG. 2.

FIG. 2 illustrates an example embodiment of base station 102 of system 100.

As illustrated in the figure, example base station 102 includes a receiver 202, a transmitter 204, a processor 206, a memory 208, an input device 210, and an output device 212. In this illustration each of receiver 202, transmitter 204, processor 206, memory 208, input device 210, and output device 212 are illustrated as distinct devices. However, at least two of receiver 202, transmitter 204, processor 206, memory 208, input device 210, and output device 212 may be combined as a unitary device. Further, in some embodiments at least one of receiver 202, transmitter 204, processor 206, memory 208, input device 210, and output device 212 may be implemented as computer-readable media for carrying or having computer-executable instructions or data structures stored thereon. Such computer-readable media can be any available media that can be accessed by a general purpose or special purpose computer. Non-limiting examples of computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Receiver 202 is arranged to receive a signal 214 from a client and to output a signal 216 to processor 206. Transmitter 204 is arranged to receive a signal 220 from processor 206 and to output a signal 230 to the client. Processor 206 is arranged to receive signal 216 from receiver 202, a signal 222 from input device 210 and to output a signal 220 to transmitter 204, a signal 224 to output device 212 and communicate with memory 208 via a signal 218.

Signals 214, 216, 218, 220, 222, 224 and 230 may be wired or wireless signals. Although, each of signals 214, 216, 218, 220, 222, 224 and 230 are illustrated as distinct signals, they all may share a predetermined frequency band within a wireless medium.

FIG. 2 shows one exemplary embodiment of how receiver 202, transmitter 204, processor 206, memory 208, input device 210, and output device 212 may be connected. However, intermediate circuitry may be included between any two devices, which are connected directly in FIG. 2.

Base station 102 is operable to manage client 104, client 106, client 108, client 110, client 112, client 114, client 116 and client 118 such that base station 102 provides a current state, a future state and/or a simulated state of each client quickly and easily using a graphical user interface (GUI). Processor 206 is operable to receive data from input device 210 and output data to output device 212. Non-limiting examples of input device 210 include a keyboard, mouse, microphone, etc. Non-limiting examples of output device 212 include a monitor, printer, TV screen, speaker, etc. Processor 206 is operable to communicate with memory 208 for data storage or data processing. Receiver 202 and transmitter 204 communicate with processor 206 for data transfer to/from clients. Processor 206 will now be further explained using FIG. 3.

FIG. 3 illustrates an example embodiment of processor 206 of base station 102 in accordance with an aspect of the present invention.

As illustrated in the figure, processor 206 includes a GUI portion 302 and an entity operator portion 301, which includes a nowcaster 304, a forecaster 306, and a simulator 308. In this illustration, each of GUI portion 302, nowcaster 304, forecaster 306 and simulator 308 are illustrated as distinct devices. However, at least two of GUI portion 302, nowcaster 304, forecaster 306, and simulator 308 may be combined as a unitary device. Further, in some embodiments at least one of GUI portion 302, nowcaster 304, forecaster 306 and simulator 308 may be implemented as computer-readable media for carrying or having computer-executable instructions or data structures stored thereon. Such computer-readable media can be any available media that can be accessed by a general purpose or special purpose computer. Non-limiting examples of computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

FIG. 3 shows one exemplary embodiment of how GUI portion 302, nowcaster 304, forecaster 306, and simulator 308 may be connected. However, intermediate circuitry may be included between any two devices which are connected directly in FIG. 3.

GUI portion 302 is arranged to communicate with simulator 308 via a signal 316, with nowcaster 304 via a signal 310 and with forecaster 306 via a signal 314. Nowcaster 304 is also arranged to communicate with forecaster 306 via a signal 312. Simulator 308 is also arranged to communicate with forecaster 306 via a signal 318.

Signals 310, 312, 314, 316 and 318 may be wired or wireless signals. Although, each of signals 310, 312, 314, 316 and 318 are illustrated as distinct signals, they all may share a predetermined frequency band within a wireless medium.

Nowcaster 304 is operable to generate current state data related to a current state of the clients connected to base station 102. Forecaster 306 is operable to generate future state data related to a future state of the clients connected to base station 102. Simulator 308 is operable to generate simulated data related to a simulated state of the clients connected to base station 102. Nowcaster 304, forecaster 306 and simulator 308 communicate with GUI portion 302 in order for processor 206 to manage and update data from the clients for providing it to output device 212.

FIG. 4 illustrates an example architectural embodiment of unitary combination of nowcaster 304, forecaster 306, and simulator 308, as entity operator portion 301 of processor 206 in accordance with an aspect of the present invention.

As illustrated in the figure, entity operator portion 301 can generate and manipulate system entity data by a domain operator 402 and functional operator 404. Domain operator 402 and functional operator 404 communicate with each other via a signal 406. Signal 406 may be a wired or wireless signal.

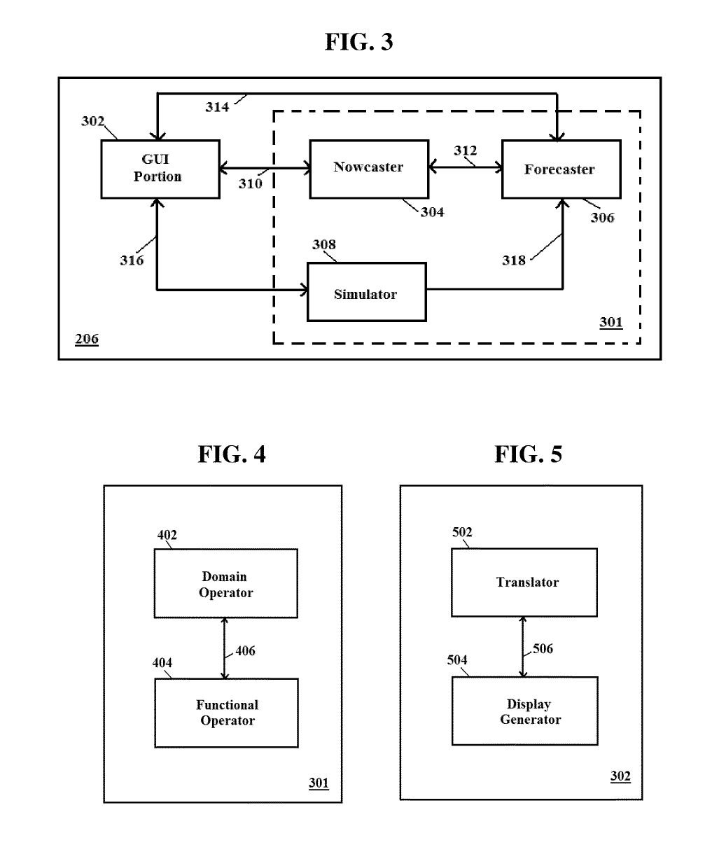

Domain operator 402 can generate and manipulate the data that simulate the system entities and their relationships. Functional operator 404 can generate and manipulate the data that simulate the system entities' functional behaviors. In such a manner, domain operator 402 and functional operator 404 may be considered the architecture for entity operator 301. GUI portion 302 will now be further explained with reference to FIG. 5.

FIG. 5 illustrates an example embodiment of GUI portion 302 of processor 206 in accordance with an aspect of the present invention.

As illustrated in the figure, GUI portion 302 includes a translator 502 and a display generator 504. Translator 502 and display generator 504 communicate with each other via signal 506. In this illustration each of translator 502 and display generator 504 are illustrated as distinct devices, however, they may be combined as a unitary device. Further, in some embodiments at least one of translator 502 and display generator 504 may be implemented as computer-readable media for carrying or having computer-executable instructions or data structures stored thereon. Such computer-readable media can be any available media that can be accessed by a general purpose or special purpose computer. Non-limiting examples of computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

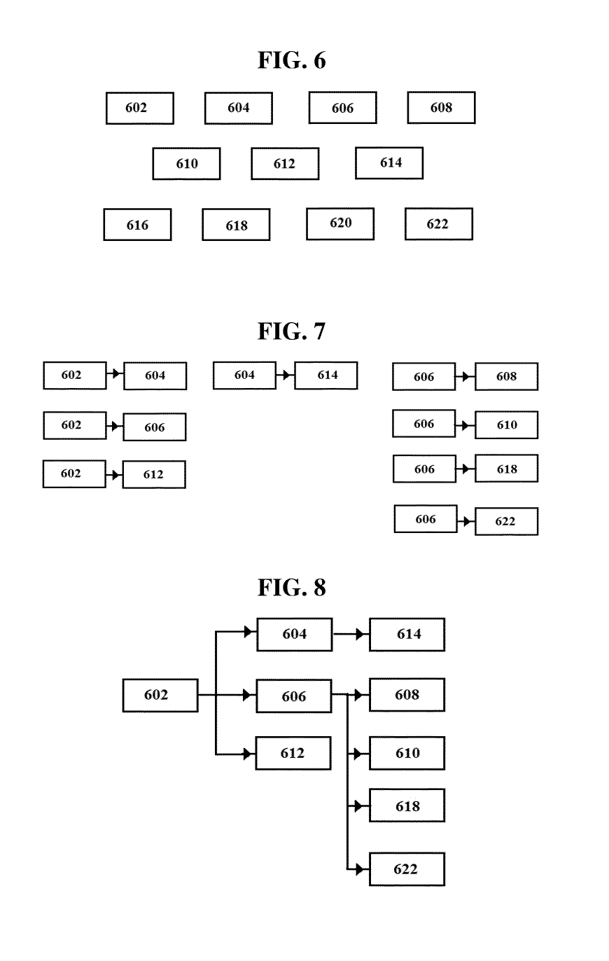

Translator 502 is operable to translate user input, via signal 222, to SEMM operational input and can translate SEMM operational output to a GUI display via signal 224. Display generator 504 creates icons associated with system entities, respectively. Display generator 504 generates and displays the SEMM Dashboard representation of the system as well as the icon representations of its entities. Display generator 504 can reflect a change to at least one of the icons based on a change in at least one of the clients or entities, by virtue of the relationships generated in the entity operator portion 301. Each system entity is associated with, and defined by, one or more characteristics, which will now be further explained with reference to FIG. 6.

FIG. 6 illustrates an example embodiment of different entities generated by entity operator portion 301 in accordance with an aspect of the present invention.

As shown, FIG. 6 illustrates entities 602, 604, 606, 608, 610, 612, 614, 616, 618, 620 and 622, which may be generated and maintained by entity operator portion 301. These entities may be dependent on the functionality or sub-functionality of the respective client or related entity. An example of a relationship between different entities is shown using FIG. 7.

FIG. 7 illustrates an example relationship between different entities in accordance with an aspect of the present invention.

As shown, FIG. 7 illustrates entity 602 related to entities 604, 606 and 612. Entity 604 is shown related to entity 614. Entity 606 is shown related to entities 608, 610, 618 and 622. These relationships between different entities may be generated and maintained by entity operator portion 301. This is described further using FIG. 8.

FIG. 8 illustrates a relationship map showing links between different entities in accordance with an aspect of the present invention.

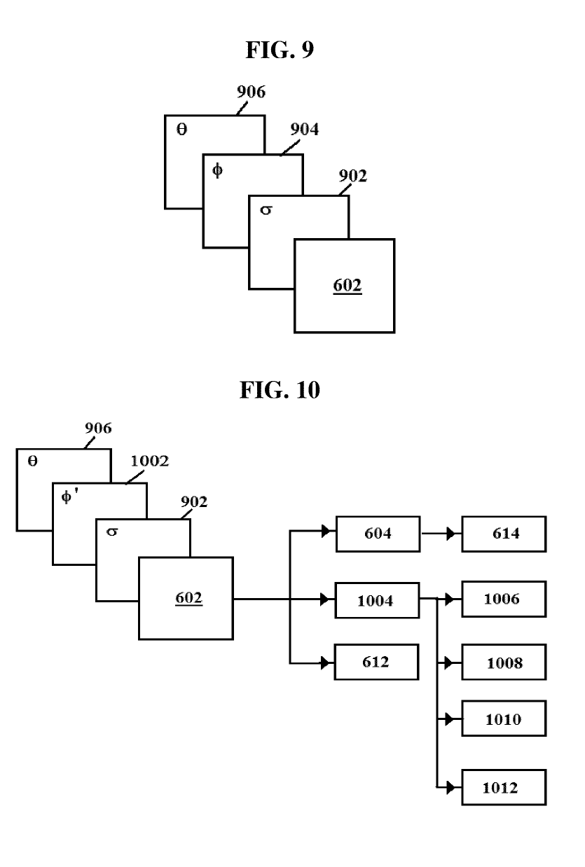

As shown, FIG. 8 illustrates entity 602 related to entity 604, which is further related to entity 614. Entity 602 is also related to entity 606, which is further related to entities 608, 610, 618 and 622. Entity 602 is also related to entity 612, which is not related to any other entity. Any change in the characteristic data of an entity can have an effect on all the other associated entities. This is described further using FIG. 9.

FIG. 9 illustrates an example embodiment of entity 602 with different characteristic data associated with it.

As shown, FIG. 9 illustrates entity 602 associated with characteristics 902, 904 and 906. Characteristic 902 is marked with a σ. Characteristic 904 is marked with an φ. Characteristic 906 is marked with a. Any change in one of the characteristics may generate a change in the entities and characteristics linked to it.

FIG. 10 illustrates an example embodiment of entity 602 with a change in one of the characteristics associated with it.

As shown, FIG. 10 illustrates entity 602 associated with characteristics 902, 1002 and 906. Characteristic 904 of FIG. 9 is changed in FIG. 10 to characteristic 1002, which is now marked as φ. As discussed above with reference to FIG. 8, entity 602 is related to entities 604 and 612. However, in this situation, instead of entity 606, entity 602 is now related to a new entity 1004. Entity 1004 is further related to new entities 1006, 1008, 1010 and 1012. Therefore a change in a characteristic provides a change in an entity, which may then generate changes to any entities connected thereto. These changes are reflected in the icon displayed by the GUI portion 302. It should be noted that a change to a system entity's characteristic, which may be referred to as feature, attribute, property, and element, may change the characteristic of that and other entities, but does that necessarily mean that these are now new entities but may be the same entities with modified characteristics; however, these entities may be referenced herein as new entities for simplicity.

As discussed above using FIGS. 1-10, system 100 includes one or more clients connected to a base station. Each client has characteristic data associated therewith, based on functionality of the client. Base station 102 includes processor 206, which processes the data to generate a current state, a future state and a simulated state for each client. Processor 206 includes GUI portion 302, which can generate display data based on the current state data, the future state data or the simulated data. GUI portion 302 further includes translator 502 and a display generator 504. Translator 502 translates user input, via signal 222, to SEMM operational input to the entity operator 301 and can translate SEMM operational output from the entity operator 301 to a GUI display, which may be provided to a user of base station 112 via signal 224 or which may be provided to a client via signal 220 to transmitter 204. Display generator 504 generates and displays the SEMM Dashboard representation of the system as well as the icon representations of its entities along with associated characteristic data used by SEMM for technical management. Display generator 504 can reflect a change to at least one of the icons based on a change in at least one of the clients or entities, by virtue of the relationships generated in the entity operator portion 301. The characteristics data may be in the form of a distributed database for a specific functionality.

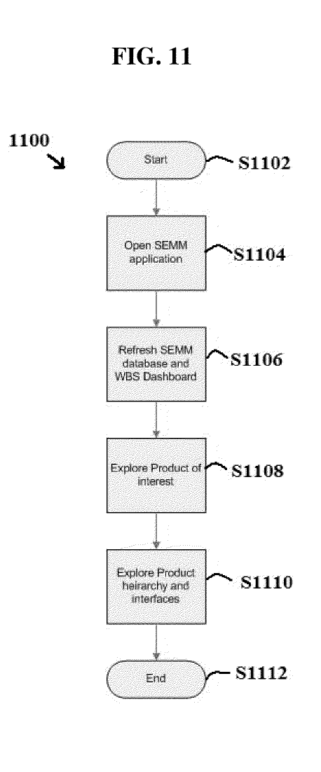

An example application of the present invention will now be discussed, which uses SEMM to effectively provide a single access point to the critical program/product information necessary for technical management of a product. The basic architecture for the SEMM is a knowledge-base, driven by a front-end user interface in the guise of a dashboard such as the Work Breakdown Structure (WBS) Dashboard representation of a system's product entities and life cycle process entities. It will be discussed further using FIGS. 11-18.

FIG. 11 illustrates an example method 1100 of SEMM in accordance with an aspect of the present invention.

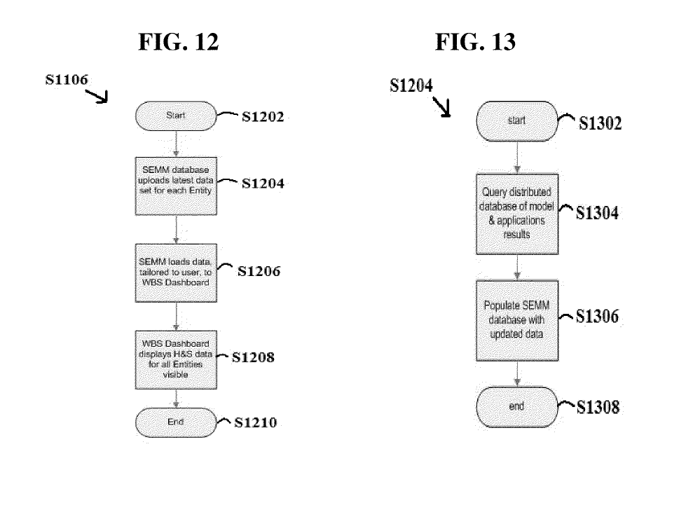

As illustrated in the figure, after method 1100 starts (S1102), a once a user opens a SEMM application (S1104). In an example embodiment, an SEMM application may take the form of hardware or software. Once the SEMM application is opened, the SEMM database and a WBS Dashboard are refreshed (S1106), a product line of interest may be explored (S1108) and product hierarchy and interfaces may be explored (S1110) before functional flow 1100 stops (S1112). The WBS Dashboard refers to the GUI representation of the system domain model (entities and their relations) which may be generated by domain operator 402. Each step follows its own hierarchy once selected. Step 1106 will now be further described with reference to FIG. 12.

FIG. 12 illustrates an example method for SEMM database and WBS Dashboard to be refreshed, corresponding to S1106 of FIG. 11 in accordance with an aspect of the present invention.

As illustrated in the figure, when SEMM database and WBS Dashboard are to be refreshed and the process starts (S1202), the SEMM database uploads the latest data set for each entity (S1204). This will be described in more detail with reference to FIG. 13.

FIG. 13 illustrates an example method for the SEMM database uploading the latest data set for each entity, corresponding to S1204 of FIG. 12 in accordance with an aspect of the present invention.

As illustrated in the figure, when the latest data set for each entity is to be uploaded and the process starts (S1302), a query is transmitted to the databases of the clients (S1304). For example, returning to FIG. 1, base station 102 may upload the latest data for each of clients 104, 106, 108, 110, 112, 114, 116 and 118. For example, returning to FIG. 2, a user may provide an instruction 226 to input device 210. Input device 210 may then provide an instruction signal 222 to processor 206 to obtain data from each of clients 104, 106, 108, 110, 112, 114, 116 and 118. Processor 206 may then instruct transmitter 204, via an instruction signal 220, to contact each of clients each of clients 104, 106, 108, 110, 112, 114, 116 and 118, to request updated data. Transmitter 204 may then contact, via an instruction signal 230, each of clients each of clients 104, 106, 108, 110, 112, 114, 116 and 118, to request updated data. Instruction signal 230 may be communicated to each of clients each of clients 104, 106, 108, 110, 112, 114, 116 and 118 by as signals 120, 122, 124, 126, 128, 130, 132 and 134, respectively.

If there is updated data, the SEMM is populated with the updated data (S1306). For example, for every client that has updated data to report, that client will provide such data back to base station 102. The data may be received by receiver 202 as a received signal 214. Receiver 202 may then provide the updated data to processor 206 via a signal 216. Processor 206 may then process the updated data and/or store the updated data in memory 208 via a storage signal 218. Returning to FIG. 3, entity operator portion 301 may use the updated data to create/modify system entities which can be displayed as icons within the GUI via GUI portion 302. For example, returning to FIGS. 4 and 6, domain operator 402 and functional operator 404 may generate new entity characterizing data and behaviors as needed for new data, whereas display generator 504 may create new icons to illustrate the updated entities as engendered by entity operator 301 and formatted by translator 502 for the GUI.

Once the new icons are created or established icons are modified, the updates are sent to nowcaster 304 and simulator 308. At this point, the SEMM database uploading the latest data set for each entity stops (S1308).

Returning to FIG. 12, now that the latest data has been uploaded (S1204), the SEMM may loads data, tailored to each client, to the WBS dashboard (S1206). This action is optional, and is designed for situations where some clients do not wish to be inundated with massive amounts of data, which is irrelevant to such clients. For example, returning to FIG. 1, suppose client 104 is responsible for managing research and development of a specific product at a plurality of geographically dispersed facilities, whereas client 108 is responsible for catering logistics of one specific facility. In this situation, client 104 may not care about the “culinary inventory” that is closely monitored and posted by client 108. As such, the SEMM, may remove all icons associated with catering logistics of client 108 for the WBS Dashboard for client 104.

Returning to FIG. 12, the SEMM may then load data for all clients to the WBS dashboard (S1208) and then the process stops (S1210).

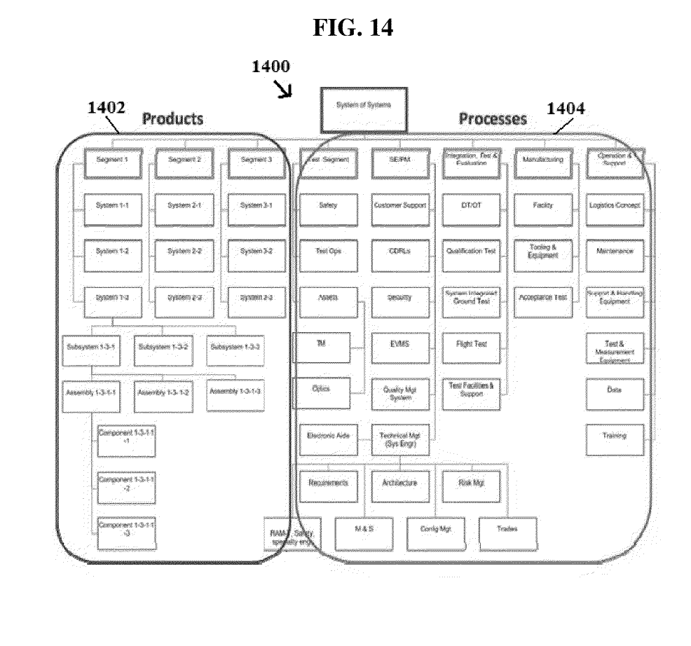

Functionality of the WBS Dashboard for SEMM will be further explained using FIG. 14.

FIG. 14 illustrates an example WBS dashboard for a system of systems using SEMM in accordance with an aspect of the present invention.

As illustrated in the figure, WBS dashboard 1400 is divided into two sets of entities: product entities 1402 and process entities 1404. WBS dashboard 1400 manifests an example high-level management model representation for product entities 1402 and process entities 1404 along with their characterizing data, including interdependencies. Product entities 1402 represent the system products under development as well as those interdependent products within the system of systems (operational system's milieu). Process entities 1404 represent the processes necessary to manage the development, operations, and support of the system (and its products) throughout its life cycle. The functionality and relationships of each entity are modeled to allow health and status reporting as well as management of requirements, risk, IPTs, and interfaces.

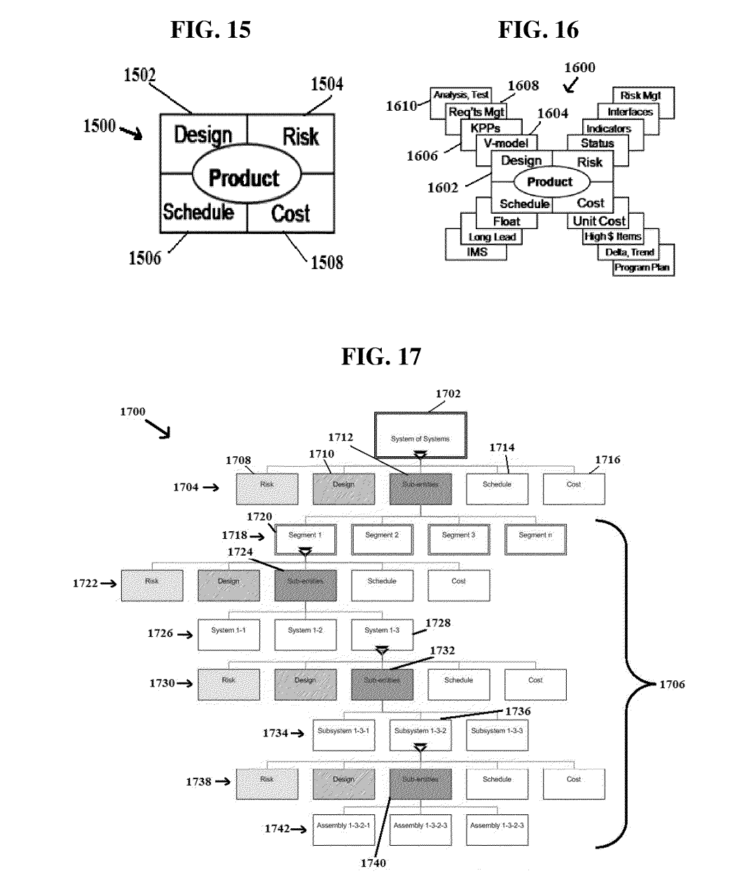

Each SEMM entity, of a given type (product or process) has certain characteristics in common with all other entities of its type: each relates to its super-class (parents) and sub-class (offspring) in a hierarchy, each possesses the same salient, defining characteristic data sets. At the entity level, these characteristics can be referred to as features. In the case of a product entity, these salient features may include design (technical solution), risk, schedule, and cost. Further explanation of the product entity is by way of FIG. 15.

FIG. 15 illustrates an example product entity and its characteristic features, which can be used to status its associated product's overall health as well as to manage its development or progress via the entity's salient features. These features can be composed of design (technical solution) 1502, risk 1504, schedule 1506 and cost 1508. Each of a product entity's features includes more detailed characteristics, which may be herein referred to as attributes. Example product entity attributes are illustrated by way of FIG. 16.

FIG. 16 illustrates an example embodiment of a SEMM product entity with its management features expanded to display their associated attributes. The attributes associated with a design feature 1602 may include V-Model, KPPs (Key Performance Parameters), requirements, and analysis and test (requirement/design verification). In turn, these attributes can be selected and expanded to delve deeper in detail and explore the product with regard to the health and status of a product's design, or to trace and allocate requirements, or to trace and attribute risk (associated with technical design, schedule, and cost), down to the lowest level of detail modeled by SEMM via entity operator portion 301. The exploration of a product entity's hierarchical structure will now be further explained with reference to FIG. 17.

FIG. 17 illustrates an example product entity hierarchy 1700 for the entity characteristic data underlying WBS dashboard 1300 using SEMM in accordance with an aspect of the present invention.

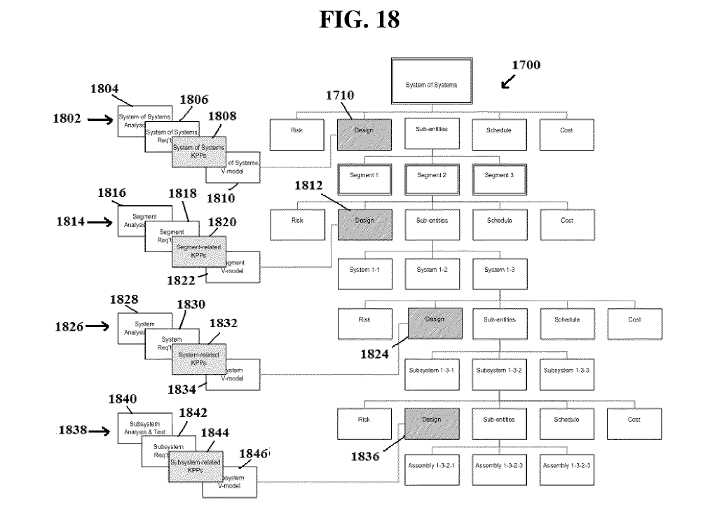

As illustrated in the figure, product entity hierarchy 1700 includes an entity 1702, a plurality of entities 1718, 1726, 1734, and 1742. The hierarchical relation of these entities, and by definition their characteristic features, is exemplified by a plurality of entities 1706, which includes the plurality of entities 1718, 1726, 1734, and 1742. In this example case, plurality of entities 1718 is at the segment level of the WBS, plurality of entities 1726 is at the system level of the WBS, plurality of entities 1734 is at the subsystem level of the WBS, and plurality of entities 1742 is at the assembly level of the WBS. Each entity, regardless of station within the WBS hierarchy, as exhibited by placement within plurality of entities 1706, includes the same characterizing datasets referred to herein as features. A plurality of features 1704 includes features for risk 1708, design 1710, hierarchy 1712, schedule 1714 and cost 1716. Plurality of features 1704 exemplifies the common architecture for entity characterizing data which allows traceability, allocation, and attribution of system management metrics, as well as interdependence between product entities. This is further illustrated by a plurality of features 1704, 1722, 1730, and 1738, which are common between the successive levels of the entity hierarchy represented by plurality of entities 1706. Tracing the path from the system of system level entity 1702 of the WBS down to the assembly level plurality of entities 1742 of the WBS is possible by the successive selection of entities 1702, 1720, 1728 and 1736 and their respective hierarchy features 1712, 1724, 1732 and 1740 via the GUI. Such a series of actions would allow the client to observe the entity characteristics for and provide opportunity to explore these characteristics by way of the entity features and attributes. The examples above and in FIG. 18 represent a domain model (consisting of entities and their relationships) for the system.

Entity hierarchy 1700 shows traceability of product design and risk in the hierarchy which share common characteristics between different entities. This traceability may be monitored in a current state, in a future state or a simulated state.

Further elaboration of system technical management using the entity design feature will be described with reference to FIG. 18.

FIG. 18 illustrates a more detailed example of product entity exploration and technical management of design progress and risk via entity hierarchy 1700 in accordance with an aspect of the present invention.

As illustrated in the figure, entity 1702 and plurality of entities 1718, 1726, 1734 and 1742, as well as plurality of features 1704, 1722, 1730 and 1738 from FIG. 17 apply. Each plurality of features can be comprised of features for risk 1708, design 1710, hierarchy 1712, schedule 1714 and cost 1716. FIG. 18 illustrates the expansion of each instance of a design feature into its constituent attributes which can include V-Model, KPPs (Key Performance Parameters), requirements, and analysis and test (requirement/design verification). In this example case, system of systems entity 1702 includes design feature 1710 which includes a plurality of attributes 1802, which includes attributes 1804, 1806, 1808 and 1810; segment entity 1801 includes design feature 1812, which includes a plurality of attributes 1814, which includes attributes 1816, 1818, 1820 and 1822; system entity 1803 includes design feature 1824, which includes a plurality of attributes 1826, which includes attributes 1828, 1830, 1832 and 1834; and sub-system entity 1805 includes design feature 1836, which includes a plurality of attributes 1838, which includes attributes 1840, 1842, 1844 and 1846.

For purposes of discussion, FIG. 18 merely illustrates characteristics, as entities, for sample entities 1710, 1812, 1824 and 1836. However, any number of entities within entity hierarchy 1700 may have a plurality of characteristics associated therewith.

With respect to monitoring a current state of a system, consider the following. In this example, presume that WBS dashboard 1300 describes the current state of performance of each of clients 104, 106, 108, 110 and 112, as generated by nowcaster 304 and displayed by GUI portion 302 as product and process entities, 1302 and 1304, respectively, each entity displaying its current state as represented by its associated icon. In such a case, any one of clients 104, 106, 108, 110 and 112 may view the current state of any of the clients by accessing WBS dashboard 1300 and entity hierarchy 1700. Graphical user interface portion 302 enables a quick, reliable, visual mechanism for any of clients 104, 106, 108, 110 and 112 to check a current state of the entire system.

With respect to monitoring a future state of a system, consider the following. In this example, presume that WBS dashboard 1300 describes the current state of performance of each of clients 104, 106, 108, 110 and 112, as generated by nowcaster 304 and displayed by GUI portion 302 as product and process entities, 1302 and 1304, respectively, each entity displaying its current state as represented by its associated icon. In such a case, any one of clients 104, 106, 108, 110 and 112 may view the current state of any of the clients by accessing WBS dashboard 1300 and entity hierarchy 1700. Graphical user interface portion 302 enables a quick, reliable, visual mechanism for any of clients 104, 106, 108, 110 and 112 to check a current state of the entire system.

With respect to simulating a future state of a system, consider the following. In this example, presume that WBS dashboard 1300 describes the current state of performance of each of clients 104, 106, 108, 110 and 112, as generated by nowcaster 304. In such a case, any one of clients 104, 106, 108, 110 and 112 may view the current state of any of the clients by accessing WBS dashboard 1300 and entity hierarchy 1700. Graphical user interface portion 302 enables a quick, reliable, visual mechanism for any of clients 104, 106, 108, 110 and 112 to check a current state of the entire system.

Program management functions, such as requirements and risk management as well as health and status monitoring, are performed by disparate agencies and individuals, using various software applications and methods. In order to maintain situational awareness on the overall health and status of a program, the program and technical management team must go to these multiple sources, compile the info, put the data in usable form, and distill them to indications of the relative strength of the program.

No single engineering management software application provides this capability for integrated program health and status observation, informed decision making, interdependency identification, and requirements and risk management. A SEMM in accordance with an aspect of the present invention fills this void in the capability for total executive management of systems and products.

A SEMM in accordance with an aspect of the present invention may be implemented as hardware or a software application that provides a single access point from which to exercise all of the systems engineering capabilities critical to success (technical solution, risk, requirements, IPTs and interfaces, etc.). A SEMM in accordance with an aspect of the present invention automates the system data manipulation, models a program's processes and products and provides the information necessary to track the health of a system and program and make informed decisions, thus providing a single user interface and focal point to facilitate timely and informed decision-making.

A SEMM in accordance with an aspect of the present invention uses a WBS representation of a program/system and its constituent entities to display interdependencies, requirements traceability and flowdown, and risk attribution, via the graphic representation of each entity with a multi-faceted icon. In this manner, system and program health and status information density is maximized to allow rapid situational awareness and informed decisions based upon characterizing data of a fidelity that imbues the user with the systems engineering capabilities critical for effective technical control and program execution. These capabilities are consonant with the attributes of good systems engineering inherent to successful programs, as highlighted by an NDIA study.

A SEMM in accordance with an aspect of the present invention could be used in any field of endeavor wherein a product is acquired, developed, demonstrated, or produced. It can be tailored in scope to model only a subsystem/segment of a system and to model the current development state of a system's life cycle. For example, a SEMM in accordance with an aspect of the present invention can model a navigation system in detail and only identify its interfaces with the rest of the vehicle; or it can model the entire vehicle and all its systems, including the navigation system. As another example of tailoring, a SEMM in accordance with an aspect of the present invention may be only as detailed as necessary to reflect the current evolutionary state of the system under development. A SEMM in accordance with an aspect of the present invention could be used for medical, defense, space, IT, automotive, etc. product development as well as for training purposes relating to a specific program or product.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device for use with a first client, a second client and a display, the first client being operable to perform a first function and to output first functional data based on a performance of the first function, the second client being operable to perform a second function and to output second functional data based on a performance of the second function, the display being operable to display an image, said device comprising:
a receiver portion operable to receive the first functional data and the second functional data;
a graphical user interface portion having a display generator portion, said graphical user interface portion being operable to generate display data, said display generator portion being operable to create a first icon and a second icon; and
an entity operator portion having a nowcasting portion, a forecasting portion, a simulating portion, a domain operator portion and a functional operator portion, said entity operator portion being operable to create a first entity and a second entity based on the first function and the second function, respectively, said nowcasting portion being operable to generate current state data based on the first functional data and the second functional data and related to a current state of the first client and a current state of the second client, said forecasting portion being operable to generate future state data based on the first functional data and the second functional data and related to a future state of the first client and a future state of the second client, said simulating portion being operable to generate simulated data based on the first functional data and the second functional data and related to a simulated state of the first client and a simulated state of the second client,
wherein the display data is based on at least one of the current state data, the future state data and the simulated data,
wherein the first icon and the second icon are based on the first entity and the second entity, respectively,
wherein said entity operator portion is further operable to change at least one of the first entity and the second entity based on a change in at least one of the current state data, the future state data and the simulated data,
wherein said entity operator portion is further operable to link the first entity and the second entity, such that a change in the first entity will generate a change in the second entity, and
wherein said display generator portion is operable to change at least one of the first icon or the second icon based on a change in at least one of the first entity and the second entity.

2. The device of claim 1, wherein said entity operator portion is further operable to generate a hierarchy of the first entity and the second entity.

3. The device of claim 2, wherein said graphical user interface portion is operable to generate a graphical representation of the hierarchy.

4. The device of claim 3, wherein said entity operator portion is further operable to generate a second hierarchy not to include one of the first entity and the second entity.

5. The device of claim 4, wherein said graphical user interface portion is further operable to generate a graphical representation of the second hierarchy.

6. The device of claim 5, further comprising a transmitter portion operable to transmit data corresponding to the hierarchy to one of the first client and the second client.

7. The device of claim 6, wherein said transmitter portion is further operable to transmit the data corresponding to the hierarchy to the first client and to transmit data corresponding to the second hierarchy to the second client.

8. The device of claim 7, wherein said transmitter portion is further operable to transmit a request to the first client and the second client for the first functional data and the second functional data.

9. A method of using a device with a first client, a second client and a display, the first client being operable to perform a first function and to output first functional data based on a performance of the first function, the second client being operable to perform a second function and to output second functional data based on a performance of the second function, the display being operable to display an image, said method comprising:
receiving, via a receiver, the first functional data and the second functional data;
generating, via a graphical user interface portion having a display generator portion, display data;
creating, via the display generator portion, a first icon and a second icon;
creating, via an entity operator portion having a nowcasting portion, a forecasting portion, a simulating portion, a domain operator portion and a functional operator portion, a first entity and a second entity based on the first function and the second function, respectively;
generating, via the nowcasting portion, current state data based on the first functional data and the second functional data and related to a current state of the first client and a current state of the second client;
generating, via the forecasting portion, future state data based on the first functional data and the second functional data and related to a future state of the first client and a future state of the second client;
generating, via the simulating portion, simulated data based on the first functional data and the second functional data and related to a simulated state of the first client and a simulated state of the second client,
wherein the display data is based on at least one of the current state data, the future state data and the simulated data,
wherein the first icon and the second icon are based on the first entity and the second entity, respectively,
wherein said creating a first entity and a second entity based on the first function and the second function, respectively, comprises changing at least one of the first entity and the second entity based on a change in at least one of the current state data, the future state data and the simulated data,
wherein said creating a first entity and a second entity based on the first function and the second function, respectively, further comprises linking the first entity and the second entity, such that a change in the first entity will generate a change in the second entity, and
wherein said creating a first icon and a second icon comprises changing at least one of the first icon or the second icon based on a change in at least one of the first entity and the second entity.

10. The method of claim 9, wherein said creating a first entity and a second entity based on the first function and the second function, respectively, further comprises generating a hierarchy of the first entity and the second entity.

11. The method of claim 10, wherein said generating display data comprises generating a graphical representation of the hierarchy.

12. The method of claim 11, wherein said creating a first entity and a second entity based on the first function and the second function, respectively, further comprises generating a second hierarchy not to include one of the first entity and the second entity.

13. The method of claim 12, wherein said generating display data further comprises generating a graphical representation of the second hierarchy.

14. The method of claim 13, further comprising transmitting, via a transmitter, data corresponding to the hierarchy to one of the first client and the second client.

15. The method of claim 14, wherein said transmitting data corresponding to the hierarchy to one of the first client and the second client comprises:
transmitting the data corresponding to the hierarchy to the first client; and
transmitting data corresponding to the second hierarchy to the second client.

16. The method of claim 15, further comprising transmitting, via the transmitter, a request to the first client and the second client for the first functional data and the second functional data.

17. A device-readable media having device-readable instructions stored thereon, the device-readable instructions being capable of being read by a device to be used with a first client, a second client and a display, the first client being operable to perform a first function and to output first functional data based on a performance of the first function, the second client being operable to perform a second function and to output second functional data based on a performance of the second function, the display being operable to display an image, the device-readable instructions being capable of instructing the device to perform the method comprising:
receiving, via a receiver, the first functional data and the second functional data;
generating, via a graphical user interface portion having a display generator portion, display data;
creating, via the display generator portion, a first icon and a second icon;
creating, via an entity operator portion having a nowcasting portion, a forecasting portion, a simulating portion, a domain operator portion and a functional operator portion, a first entity and a second entity based on the first function and the second function, respectively;
generating, via the nowcasting portion, current state data based on the first functional data and the second functional data and related to a current state of the first client and a current state of the second client;
generating, via the forecasting portion, future state data based on the first functional data and the second functional data and related to a future state of the first client and a future state of the second client;
generating, via the simulating portion, simulated data based on the first functional data and the second functional data and related to a simulated state of the first client and a simulated state of the second client,
wherein the display data is based on at least one of the current state data, the future state data and the simulated data,
wherein the first icon and the second icon are based on the first entity and the second entity, respectively,
wherein said creating a first entity and a second entity based on the first function and the second function, respectively, comprises changing at least one of the first entity and the second entity based on a change in at least one of the current state data, the future state data and the simulated data,
wherein said creating a first entity and a second entity based on the first function and the second function, respectively, further comprises linking the first entity and the second entity, such that a change in the first entity will generate a change in the second entity, and
wherein said creating a first icon and a second icon comprises changing at least one of the first icon or the second icon based on a change in at least one of the first entity and the second entity.

18. The device-readable media of claim 17, the device-readable instructions being capable of instructing the device to perform said creating a first entity and a second entity based on the first function and the second function, respectively, so as to further comprise generating a hierarchy of the first entity and the second entity.

19. The device-readable media of claim 18, the device-readable instructions being capable of instructing the device to perform said generating display data so as to comprise generating a graphical representation of the hierarchy.

20. The device-readable media of claim 19, the device-readable instructions being capable of instructing the device to perform said creating a first entity and a second entity based on the first function and the second function, respectively, so as to further comprise generating a second hierarchy not to include one of the first entity and the second entity.
